(19) United States
(12) Patent Application Publication
(10) Pub. No.: US 2016/0333915 A1
(43) Pub. Date: Nov. 17, 2016

(54) SNAP-ON CONNECTION APPARATUS

(71) Applicant: Gökhan KAYALIBAY, Istanbul (TR)

(72) Inventor: Gökhan KAYALIBAY, Istanbul (TR)

(21) Appl. No.: 14/841,904

(22) Filed: Sep. 1, 2015

(30) Foreign Application Priority Data
May 15, 2015 (TR) 2015/05900

(51) Int. Cl. F16B 21/06

(52) U.S. Cl. CPC F16B 21/06

(57) ABSTRACT

The multi-purpose snap-on connection apparatus enables attachment apparatuses, such as wheels, hooks, fastening rings, to be simply assembled and disassembled. The attachment apparatuses are occasionally required for attaching to/removing from an object during the usage of the objects. The snap-on connection apparatus is enabled to be used under heavy loads which do not require tools. The snap-on connection apparatus is attachable and removable by hand and easy to manufacture.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a multi-purpose snap-on connection apparatus which enables attachment apparatuses (such as a wheels, hooks, fastening rings), occasionally required for attaching to/removing from an object during the usage of the objects, to be simply assembled and disassembled, enables them to be used under heavy loads which do not require tools (attachable and removable by hand), and is easy to manufacture.

2. Description of Related Art Including Information Disclosed Under 37 CFR 1.97 and 37 CFR 1.98.

The connection elements sector comprises of materials used in the integration of industrial products, especially screws, bolts, studs, gaskets, washers, rivets, etc. by coupling them together. They are not only used in industrial products, but they also enable all objects, used by people throughout their lives, to stay together.

Nowadays, screws and bolts are the most commonly used connection elements.

Connection elements need to be capable of carrying heavy loads and being strong. Thus, connection elements are nowadays generally manufactured from metal.

Of the connection elements used, bolts are connection elements which are used by opening holes on pieces that are desired to be connected together and inserting and tightening studs on the bolt ends. Generally, they are used with studs.

Various tools are used during the assembly phase of bolts, screws and similar products being connection elements used today. Thus, the assembly process cannot be completed without these tools.

### SUMMARY OF THE INVENTION

The present invention has been improved, taking the issues mentioned in the known state of the art into account, and with the object of eliminating these issues.

The present invention is a multi-purpose snap-on connection part which enables attachment apparatuses (such as a wheels, hooks, fastening rings), occasionally required for attaching to/removing from an object during the usage of the objects, to be simply assembled and disassembled, enables them to be used under heavy loads which do not require tools (attachable and removable by hand), and consists of two parts.

The present invention can be designed in various forms according to the different needs of utilisation. Also, it is possible to be designed with different suitable manufacturing techniques depending on the manufacturing costs.

In the present invention, each apparatus set is fundamentally comprised of two elements. The main element is designed so as to be assembled to the object to which it will be connected. The auxiliary element is designed so as to be assembled to the object to be connected.

In the present invention, an additional device or tool is not required to connect or remove the main element and auxiliary element to or from each other after assembling the main element and auxiliary element.

In the present invention, the design can be adjusted according to the required load capacity.

In the present invention, the assembly/disassembly process can be readily performed if there is any abrasion due to the operation with the main element and auxiliary element. This abrasion does not affect the connected object nor the connecting object.

The present invention can be designed in the desired measurements and dimensions. In the invention, the main element and the auxiliary element can be designed in various forms. The main element may be comprised of more than one part according to the form. Also, various security lock pins may be used depending on the type.

The present invention can be manufactured in four varieties: a simple snap-on apparatus, a standard slide-in, an advanced swing lock and a double slide-in advanced swing lock.

In the present invention, the snap-on connection apparatus may be manufactured from wood, plastic, composite material and metals such as aluminium, bronze, titanium and/or chrome steel.

In the present invention, the capacity can be adjusted by scaling the snap-on connection apparatus model according to the necessary load capacity.

The present invention may also be manufactured with casting techniques, as well as with CNC milling machines.

In the present invention, the auxiliary element is designed to fit onto a shaft or pivot, and this design may be changed according to the properties of the part to be connected.

In the present invention, all of the snap-on connection elements are comprised of one main element and one auxiliary element. It is also possible for it to be screwed to various points for it's assembly to the part to which it will be connected specifically for the use of the main elements. Furthermore, the main element can be manufactured protrudingly, specifically for the part to which it will be connected.

### PARTS AND PIECES CONSTITUTING THE INVENTION

1. Main element
1.1. Assembly holes
1.2. Security pin recesses
1.3. Slide
2. Auxiliary element
3. Pin

### BRIEF DESCRIPTION OF THE DRAWINGS

FIG. 1 shows alternative perspective views of the main element.

FIG. 2 shows alternative views of the main element being assembled to the object.

FIG. 3 shows alternative perspective views of the auxiliary element.

FIG. 4 shows alternative views of the auxiliary element being assembled to the object.

FIG. 5 shows a view of the simple snap-on connection apparatus being disassembled.

FIG. 6 shows a view of the standard slide-in connection apparatus being disassembled.

FIG. 7 shows a view of the advanced swing lock connection apparatus being disassembled.

FIG. 8 shows a view of the advanced double slide-in connection apparatus being disassembled.

FIG. 9 shows a general view of an alternative main element and alternative auxiliary element.

FIG. 10 shows a view of the auxiliary member rotated 90° in the axis of x.

FIG. 11 shows a view of the auxiliary element connected to the main member.

FIG. 12 shows a view of the auxiliary member turned downwards into the main member.

FIG. 13 shows a view of the auxiliary element placed into the main element.

FIG. 14 shows a view of the pins placed into the main element.

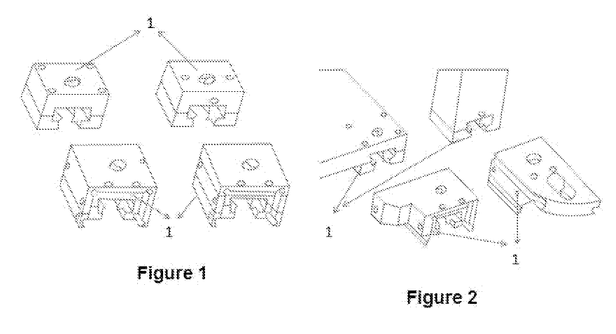

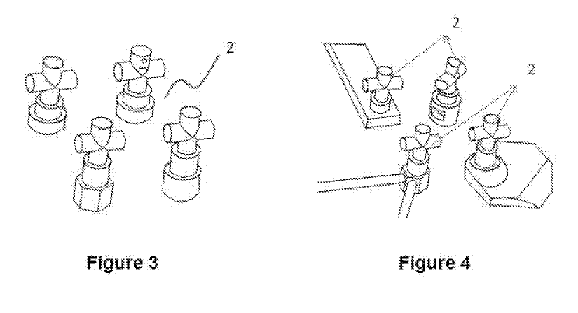

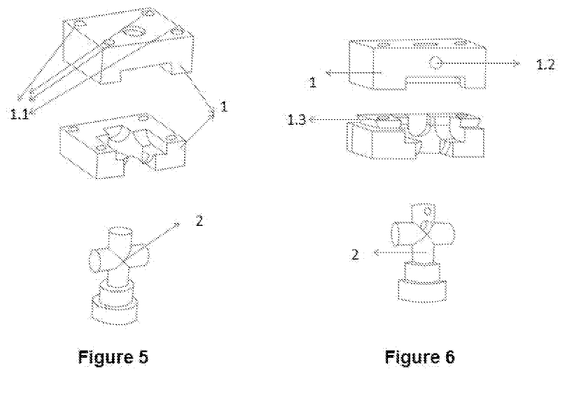

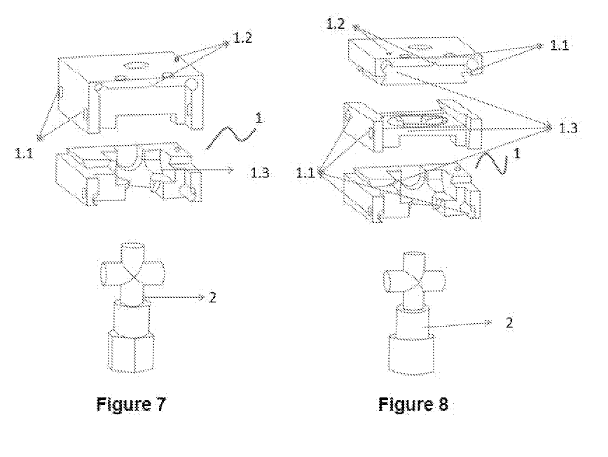

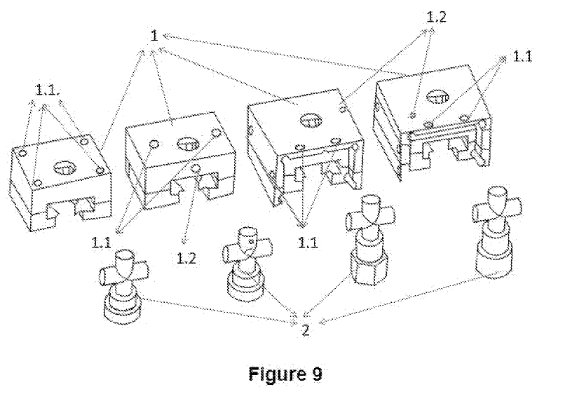

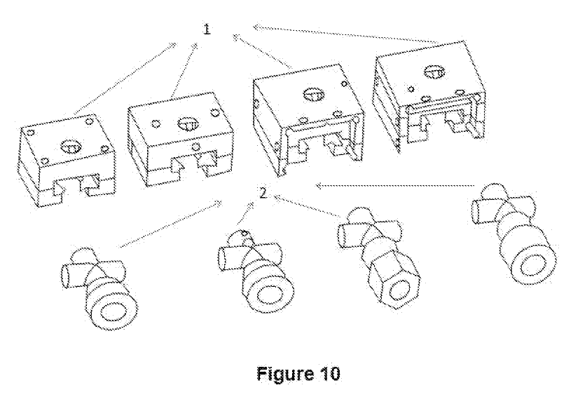

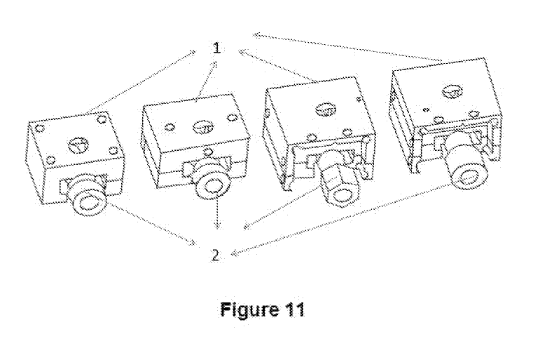

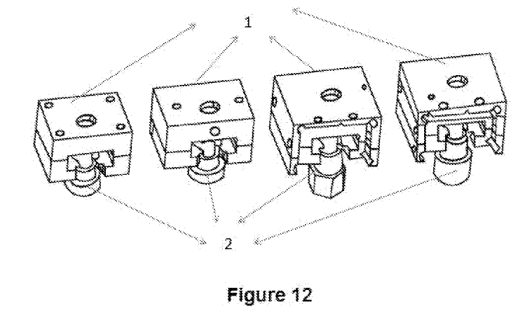

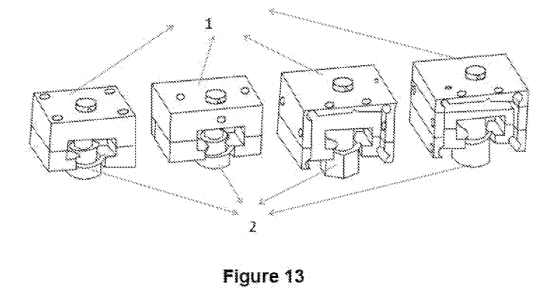

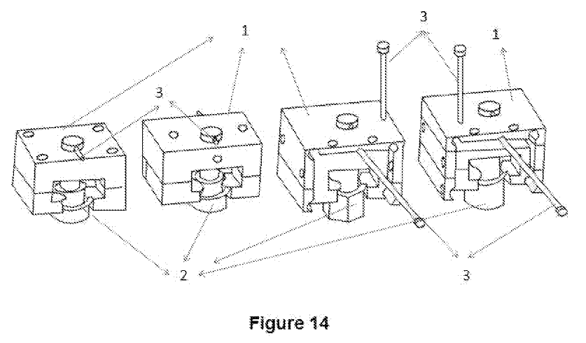

### DETAILED DESCRIPTION OF THE DRAWINGS

Referring The present invention is a snap-on connection apparatus comprising of a main element (1), main element assembly holes (1.1), security pin recesses (1.2), a slide (1.3), an auxiliary element (2) and pins (3).

Within itself, the main element (1) contains main element assembly holes (1.1), security pin recesses (1.2) and a slide (1.3), and is in the main body fixed with main element assembly holes (1.1) to assemble the desired object.

The main element assembly holes (1.1) are found within the main element (1), and are the part having slots to serve for fixing the main element (1) to a desired object.

The security pin recesses (1.2) are found on the main element (1), where the pins (3) have been inserted to provide strength after enabling the locking of the main element (1) and the auxiliary element (2).

The slide (1.3) is inserted onto the lower part of main element (1), and is the part in which the auxiliary element (2) inserted and moved.

The auxiliary element (2) is inserted onto the slide (1.3) of the main element (1), and is the part which can be rotated in the axis of x, y and z in order to enable locking.

The pin (3) is inserted into security pin recesses (1.2) found on the main element (1), and is the part which increases the strength.

In the present invention the auxiliary element (2) is rotated 90° in the axis of x towards the main element (1), then the auxiliary element (2) is pushed in the axis of y towards the main element (1) and the auxiliary element (2) is rotated 90° downwards in the opposite direction of the previous rotation. When the auxiliary element (2) is pushed upwards in the axis of z, the locking process is completed. The simple snap-on connection and the standard snap-on connection apparatus take their final positions and the locking is completed by inserting the security pins (3) in order to increase optional strength.

According to two other varieties in the present invention, the locking is completed by rotating the advanced slide-in connection apparatus and the double slide-in snap-on connection apparatus 110° clockwise in the axis of z when viewed from below. The security pins (3) can optionally be inserted in order to increase the strength.

In the present invention, the disassembly process can be done by performing the process steps of locking in the reverse order.

1. A snap-on connection apparatus, comprising:
a main element;
main element assembly holes;
security pin recesses;
a slide;
an auxiliary element; and
pins.

2. The snap-on connection apparatus according to claim 1, wherein said main element assembly holes, said security pin recesses and a said slide are contained in said main element, and wherein said main element assembly holes are fixed on said main element so as to assemble a desired object.

3. The snap-on connection apparatus according to claim 1, wherein said main element assembly holes are fixed on said main element and have slots so as to fix said main element to a desired object.

4. The snap-on connection apparatus according to claim 1, wherein said security pin recesses are mounted in said main element and wherein said pins insert through said security pin recesses so as to provide strength after locking said main element and said auxiliary element.

5. The snap-on connection apparatus according to claim 1, wherein said slide inserts onto a lower part of said main element, said auxiliary element being inserted and moved in said slide.

6. The snap-on connection apparatus according to claim 1, wherein said main element inserts onto said slide, said auxiliary element being rotatable on multiple axes so as to enable locking.

7. The snap-on connection apparatus according to claim 1, wherein said security pin recesses are inserted into said main elements, said pin inserting through said security pin recesses so as to increase strength.
